(19) United States
(12) Patent Application Publication
(10) Pub. No.: US 2022/0027049 A1
(43) Pub. Date: Jan. 27, 2022

(54) STORING A DATA BLOCK IN A LOG-STRUCTURED RAID DRIVE ARRAY

(71) Applicant: International Business Machines Corporation, Armonk, NY (US)

(72) Inventors: Gareth Paul Jones, Hampshire (GB); BEN SASSON, North Baddesley (GB); Lee Jason Sanders, Chichester (GB); GORDON DOUGLAS HUTCHISON, Eastleigh (GB)

(21) Appl. No.: 16/936,578

(22) Filed: Jul. 23, 2020

(51) Int. Cl. G06F 3/06

(52) U.S. Cl. CPC G06F 3/064; G06F 3/0689; G06F 3/0604; G06F 3/0631

(57) ABSTRACT

Concepts for storing a data block in a plurality of at least three storage units forming a RAID drive array are presented. The RAID drive array operates using a log-structured filing system. Dividing the data block into at least two sets of data sub-blocks and generating check data for the at least two sets of data sub-blocks, the check data enabling the reconstruction of one of the sets of data sub-blocks using the other set or sets of data sub-blocks. Further storing each set of data sub-blocks and the check data in a different storage unit and obtaining location metadata that identifies a physical location for the data sub-blocks within the storage unit in which the respective data sub-blocks are stored and storing a copy of the location metadata in at least two storage units.

### BACKGROUND

The present invention relates generally to data storage systems and methods, and more particularly to methods of storing data in a plurality of at least three storage units forming a RAID drive array.

The present invention also relates to a computer-implemented method for storing a data block in a plurality of at least three storage units forming a RAID drive array.

The present invention also relates to a computer program product comprising computer-readable program code that enables a processor of a system, or a number of processors of a network, to implement such a method.

The present invention also relates to a processing system comprising at least one processor and such a computer program product, wherein the at least one processor is adapted to execute the computer program code of said computer program product.

The present invention also relates to a processing system for storing a data block in a plurality of at least three storage units forming a RAID drive array.

In the field of computer data storage, the process of data striping is a technique for segmenting logically sequential data, such as a file, so that consecutive segments are stored on different physical storage devices. Data striping may be applied when a processing device requests data more quickly than a single storage device can provide it. By spreading segments across multiple devices that can be accessed concurrently, total data throughput is increased. A data striping technique facilitates balancing I/O load across an array of disks. Data striping is also used across disk drives in a redundant array of independent/inexpensive disks/drives (RAID) storage, network interface controllers, disk arrays, different computers in clustered file systems and in grid-oriented storage, and/or random access memory (RAM).

A RAID is a drive array that allows storage of data to be distributed across a plurality of different storage units. There are a number of standard storage mechanisms for such drive arrays that are traditionally used to store data and are commonly referred to as levels. Raid 0 is one known storage mechanism, in which data is striped across different storage units. Raid 1 is another storage mechanism, in which data is mirrored, i.e. copied, across multiple storage units. Raid 5/6 are other storage mechanisms in which data is striped across different storage units, and parity data is generated and stored, to enable stored data to be reconstructed should a drive failure occur.

### SUMMARY

In one aspect of the present invention, a method, a computer program product, and a system includes: (i) dividing the data block into at least two sets of data sub-blocks; (ii) generating check data for the at least two sets of data sub-blocks, the check data enabling the reconstruction of one of the sets of data sub-blocks using the other set or sets of data sub-blocks; (iii) storing each set of data sub-blocks and the check data in a different storage unit; (iv) obtaining location metadata that identifies a physical location for the data sub-blocks within the storage unit in which the respective data sub-blocks are stored; and (v) storing a copy of the location metadata in at least two storage units.

The present invention seeks to provide a computer-implemented method for storing a data block in a plurality of at least three storage units forming a RAID drive array, the RAID drive array operating using a log-structured filing system.

The present invention also seeks to provide a computer program product comprising computer-readable program code that enables a processor of a system, or a number of processors of a network, to implement such a proposed method.

The present invention also seeks to provide a processing system comprising at least one processor and such a computer program product, wherein the at least one processor is adapted to execute the computer program code of said computer program product.

The present invention also seeks to provide a processing system for storing a data block in a plurality of at least three storage units forming a RAID drive array, the RAID drive array operating using a log-structured filing system.

According to an aspect of the invention, there is provided a computer-implemented method. The computer-implemented method is designed for storing a data block in a plurality of at least three storage units forming a RAID drive array. The RAID drive array operates using a log-structured filing system.

The computer-implemented method comprises dividing a data block into at least two sets of one or more data sub-blocks; and then generating check data for the at least two sets of one or more data sub-blocks, the check data enabling the reconstruction of one of the sets of one or more data sub-blocks using the other set or sets of one or more data sub-blocks. The method then comprises storing each set of one or more data sub-blocks and the check data in a different storage unit. The method then comprises obtaining location metadata that identifies a physical location for the data sub-blocks within the storage unit in which the respective data sub-blocks are stored; and storing a copy of the location metadata in at least two storage units.

According to another aspect of the invention, there is provided a processing system. The processing system is designed for storing a data block in a plurality of at least three storage units forming a RAID drive array, the RAID drive array operating using a log-structured filing system.

The processing system comprises a dividing component configured to divide the data block into at least two sets of one or more data sub-blocks; and a check generation component configured to generate check data for the at least two sets of one or more data sub-blocks, the check data enabling the reconstruction of one of the sets of one or more data sub-blocks using the other set or sets of one or more data sub-blocks. The processing system further comprises a storing component configured to store each set of one or more data sub-blocks and the check data in a different storage unit. The processing system yet further comprises a location metadata processing component configured to obtain location metadata that identifies a physical location for the data sub-blocks within the storage unit in which the respective data sub-blocks are stored, wherein the storing component is further configured to store a copy of the location metadata in at least two storage units.

According to another aspect of the invention, there is provided a computer program product for storing a data block in a plurality of at least three storage units forming a RAID drive array, the RAID drive array operating using a log-structured filing system. The computer program product comprises a computer readable storage medium having program instructions embodied therewith, the program instructions executable by a processing system to cause the processing system to perform a method according to a proposed embodiment.

According to another aspect of the invention, there is provided a processing system comprising at least one processor and the computer program product according to an embodiment. The at least one processor is adapted to execute the computer program code of said computer program product.

### BRIEF DESCRIPTION OF THE SEVERAL VIEWS OF THE DRAWINGS

FIG. 1 depicts a pictorial representation of an example distributed system in which aspects of the illustrative embodiments may be implemented;

FIG. 2 is a block diagram of an example system in which aspects of the illustrative embodiments may be implemented;

FIG. 3 is a flow diagram of a method for an embodiment of the invention;

FIG. 4 is a simplified block diagram of an exemplary embodiment of a system; and

FIG. 5 is a block diagram of another example system in which aspects of the illustrative embodiments may be implemented.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method may be a process for execution by a computer, i.e. may be a computer-implementable method. The various steps of the method may therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

Interest has grown in the use of log-structured file systems, in which a storage arrangement (e.g. a RAID drive array) is arranged as a large log, with new data for storage being sequentially written to the end of the log. Superseded data in a log-structured filing system, i.e. data that has been replaced by newly written data, is marked as invalid or no longer in use, and can be cleaned up (e.g. deleted) in a clean-up or garbage collection process. In a log-structured filing system, there is no fixed mapping between the logical (or “virtual”) block address of the data and its physical location in the storage arrangement, thereby requiring the generation of metadata for identifying the location of a desired data block within the storage arrangement. In particular, location metadata (forward lookup data) should be generated and maintained to enable the physical location of a desired data block within the storage arrangement (i.e. its position within the log) to be identified from a logical block address or logical position.

In this disclosure, the terms data and metadata are used in different ways. While metadata is also data, the term metadata as used herein refers to data that specifies information about the data, identifying, for example, the nature and feature of the data. The term data as used herein refers to content of a file, such as a piece of information, a list of measurements or observations, or a story or a description of a certain physical object. An effort to distinguish the terms “data” and “metadata” is employed in this document such that “actual data,” “data block,” and “content data” refer to data as the term is described above while the term “metadata” is used by itself, without a descriptive name.

Embodiments propose a new storage mechanism for a RAID drive array operating using a log-structured filing system. The proposed embodiments enable metadata for a log-structured filing system of a RAID drive array to be reconstructed rapidly in the event of a disk/drive failure. In particular, this enables rapid restoration of redundancy within the RAID drive array, while reducing any write amplification that may be caused by metadata updates.

Effectively, the present application proposes to mirror or copy metadata generated for data stored by a log-structured file system across multiple storage units of a RAID drive array, e.g. in a manner analogous to a RAID 1 approach. Meanwhile, the application proposes to store the data associated with the metadata across the RAID drive array along with appropriate check or parity data, e.g. in a manner analogous to a RAID 5/6 approach. Effectively, the present application proposes a hybrid approach, which provides a different form of redundancy to metadata for a log as for data of the log.

Metadata generated for a log-structured filing approach is typically extremely small, so that mirroring metadata would not significant decrease storage capacity of the overall RAID storage system (e.g. compared to mirroring of data), while enabling rapid restoration of redundancy for the metadata and avoiding potentially complex and time consuming reconstruction.

Embodiments may be implemented in any suitable RAID storage system that operates according to a log-structured filing system, e.g. in the field of personal computing, cloud computing or business computer implementations.

The inventors therefore propose a new mechanism (i.e. method, concept or approach) for storing a data block within a RAID drive array, which is formed of a plurality of data storage units. The data block may comprise any data of a log that a processing system desires to be stored within a RAID drive array, e.g. a cache of data to be appended to a log.

The mechanism comprises dividing or splitting the data block into two or more sets of one or more data sub-blocks, i.e. striping the data block. The mechanism then comprises generating check data, e.g. parity data, for the two or more sets. As would be known to the skilled person, check data is designed to enable the reconstruction or rebuilding of one of the sets from the other set(s), e.g. in the event of a disk failure. The two or more sets of one or more data sub-blocks, and the check data, are then stored in a distributed manner across the storage units of the RAID drive array, i.e. so that each set and the check data is stored in a different storage unit.

Effectively, the process to this point is analogous to a RAID 5/6 storage of data.

The mechanism also comprises generating location metadata for the data sub-blocks. The location metadata may identify a relationship between a logical address for the data block (e.g. the sub-blocks) and a physical location of the data block within the RAID drive array.

The location metadata is effectively forward lookup data that enables the physical location of a data block to be identified, thereby enabling a processing system to identify and read the content of a data block.

Copies of the location metadata are stored in at least two of the storage units of the RAID drive array. Effectively, the metadata is stored using a RAID 1 approach for storing data.

The present invention thereby provides a hybrid mechanism for storing data and metadata within a RAID drive array, in which data is stored in a manner analogous to a RAID 5/6 approach and corresponding metadata is stored in a manner analogous to a RAID 1 approach.

This enables a mixed approach for the storage of data and metadata and introduces new variations and flexibility for different types of redundancies when storing data, whether content data or metadata.

In some embodiments, the step of generating check data comprises generating a first check data sub-block and a second, different check data sub-block, the first and second check data sub-blocks together enabling the reconstruction of two of the sets of one or more data sub-blocks using the other sets of one or more data sub-blocks; and the step of storing each set of one or more data sub-block and the check data comprises storing each set of one or more data sub-blocks and each check data sub-block in a different storage unit.

In some embodiments, the method further comprises steps of obtaining identifying metadata for the block of data; and storing the identifying metadata in at least two storage units. In this way, further metadata or reverse lookup data for the block of data can be stored in a same manner to the location metadata. Reverse lookup data can be an important aspect of log-structured storage solutions, enabling the identification of invalid or superseded stored data (e.g. data that has been superseded by a new write of the log).

In particular, the identifying metadata may identify a relationship between a physical location of the data sub-blocks of the data block within the RAID drive array and the logical address for the data sub-block within a log. When the data is superseded, the logical address in the identifying metadata may be marked as invalid, superseded or “none,” e.g. ready for cleaning or deletion. Other methods of invalidating data would be apparent to the skilled person, e.g. by generating a flag or marker for a piece of data.

Preferably, the steps of obtaining and storing identifying metadata for each data sub-block and the check data are performed before storing the location metadata. This helps ensure that data is not lost or corrupted in the event of a controller outage where the controller controls the storing of data in the RAID array.

Preferably, the step of storing a copy of the location metadata in at least two storage units comprises storing a copy of the location metadata in at least three storage units. This increases the redundancy for the location metadata, meaning that any two drives (storage units) are able to fail without losing the ability to restore the location metadata promptly.

Preferably, the location metadata is the same size as the sector size of any of the storage units. In some embodiments, the location metadata identifies the size of the data block, e.g. how many sub-blocks or addresses are occupied by the data block in the RAID drive array. In at least one embodiment, the location metadata comprises a compression flag indicating whether or not a sub-block has been compressed.

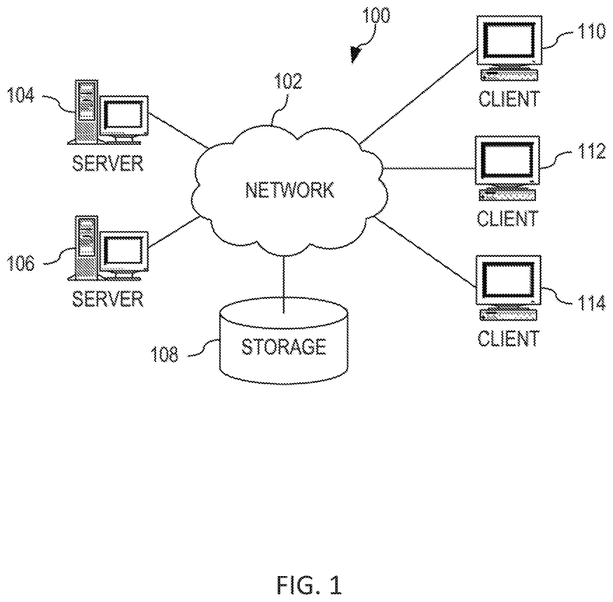

FIG. 1 depicts a pictorial representation of an exemplary distributed system in which aspects of the illustrative embodiments may be implemented. Distributed system 100 may include a network of computers in which aspects of the illustrative embodiments may be implemented. The distributed system 100 contains at least one network 102, which is the medium used to provide communication links between various devices and computers connected together within the distributed data processing system 100. The network 102 may include connections, such as wire, wireless communication links, or fiber optic cables.

In the depicted example, first server 104 and second server 106 are connected to the network 102 along with a RAID drive array 108. The RAID drive array is formed from a plurality of data storage units. In addition, clients 110, 112, and 114 are also connected to the network 102. The clients 110, 112, and 114 may be, for example, personal computers, network computers, or the like. In the depicted example, the first server provides data, such as boot files, operating system images, and applications to clients 110, 112, and 114. Clients 110, 112, and 114 are clients to the first server in the depicted example. Distributed processing system 100 may include additional servers, clients, and other devices not shown.

In the depicted example, distributed processing system 100 is the Internet with the network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

The network 102 may be configured to perform one or more methods according to an embodiment of the invention, e.g. to control the storage of data within the RAID drive array 108.

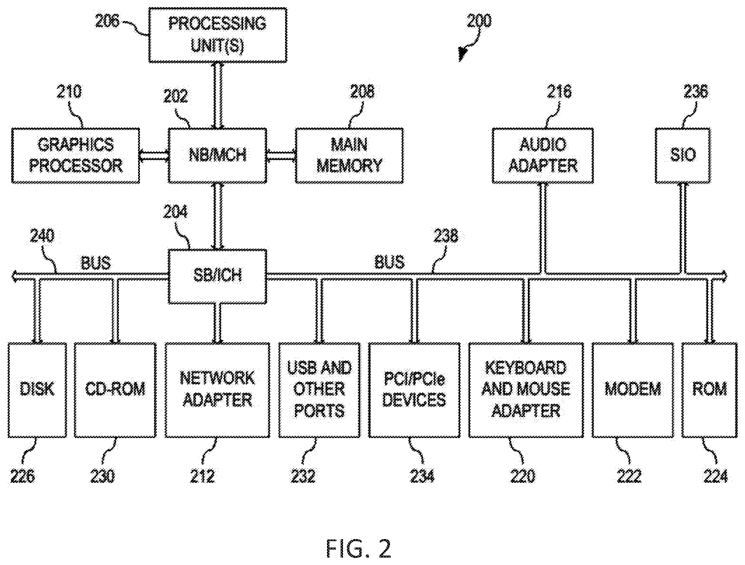

FIG. 2 is a block diagram of an example system 200 in which aspects of the illustrative embodiments may be implemented. The system 200 is an example of a computer, such as client 110 in FIG. 1, in which computer usable code or instructions implementing the processes for illustrative embodiments of the present invention may be located. For instance, the system 200 may be configured to implement an identifying unit, an associating unit, and a creating unit according to an embodiment.

In the depicted example, the system 200 employs a hub architecture including a north bridge and memory controller hub (NB/MCH) 202 and a south bridge and input/output (I/O) controller hub (SB/ICH) 204. A processing system 206, a main memory 208, and a graphics processor 210 are connected to NB/MCH 202. The graphics processor 210 may be connected to the NB/MCH 202 through an accelerated graphics port (AGP).

In the depicted example, a local area network (LAN) adapter 212 connects to SB/ICH 204. An audio adapter 216, a keyboard and a mouse adapter 220, a modem 222, a read only memory (ROM) 224, a hard disk drive (HDD) 226, a CD-ROM drive 230, a universal serial bus (USB) ports and other communication ports 232, and PCI/PCIe devices 234 connect to the SB/ICH 204 through first bus 238 and second bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

The HDD 226 and CD-ROM drive 230 connect to the SB/ICH 204 through second bus 240. The HDD 226 and CD-ROM drive 230 may use, for example, an integrated drive electronics (IDE) or a serial advanced technology attachment (SATA) interface. Super I/O (SIO) device 236 may be connected to SB/ICH 204.

An operating system runs on the processing system 206. The operating system coordinates and provides control of various components within the system 200 in FIG. 2. As a client, the operating system may be a commercially available operating system. An object-oriented programming system, such as the Java programming system, may run in conjunction with the operating system and provides calls to the operating system from Java programs or applications executing on system 200. (Note: the term “JAVA” may be subject to trademark rights in various jurisdictions throughout the world and are used here only in reference to the products or services properly denominated by the marks to the extent that such trademark rights may exist.)

As a server, system 200 may be, for example, an IBM® eServer™ System p® computer system, running the Advanced Interactive Executive (AIX) operating system or the LINUX operating system. The system 200 may be a symmetric multiprocessor (SMP) system including a plurality of processors in processing system 206. Alternatively, a single processor system may be employed. (Note: the term(s) “AIX” and/or “LINUX” may be subject to trademark rights in various jurisdictions throughout the world and are used here only in reference to the products or services properly denominated by the marks to the extent that such trademark rights may exist.)

Instructions for the operating system, the programming system, and applications or programs are located on storage devices, such as HDD 226, and may be loaded into main memory 208 for execution by processing system 206. Similarly, one or more message processing programs according to an embodiment may be adapted to be stored by the storage devices and/or the main memory 208.

The processes for illustrative embodiments of the present invention may be performed by processing system 206 using computer usable program code, which may be located in a memory such as, for example, main memory 208, ROM 224, or in one or more peripheral devices 226 and 230.

In particular, the processing system 206 may be adapted to perform one or more methods according to embodiments of the invention. In particular, the HDD 226 could comprise a RAID drive array, for which the processing system 206 controls the storage of data therein.

A bus system, such as first bus 238 or second bus 240 as shown in FIG. 2, may comprise one or more buses. Of course, the bus system may be implemented using any type of communication fabric or architecture that provides for a transfer of data between different components or devices attached to the fabric or architecture. A communication unit, such as the modem 222 or the network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the system mentioned previously, without departing from the spirit and scope of the present invention.

Moreover, the system 200 may take the form of any of a number of different data processing systems including client computing devices, server computing devices, a tablet computer, laptop computer, telephone or other communication device, a personal digital assistant (PDA), or the like. In some illustrative examples, the system 200 may be a portable computing device that is configured with flash memory to provide non-volatile memory for storing operating system files and/or user-generated data, for example. Thus, the system 200 may essentially be any known or later-developed data processing system without architectural limitation.

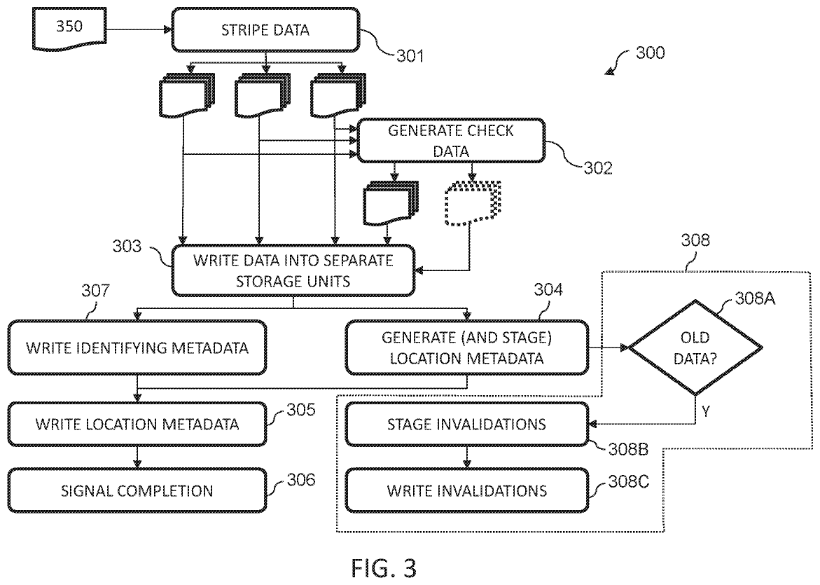

Referring now to FIG. 3, there is depicted a flow diagram of a computer-implemented method 300 for storing a data block 350 in a plurality of at least three storage units forming a RAID drive array.

The method 300 may be performed by any suitable processing system designed for storing data in a RAID drive array using a log-structured filing system/approach. In such a system, data is written sequentially, so that new versions of a piece of data are appended to a log rather than existing data being updated in the original position. A log-structured filing system would be well known to the skilled person.

A RAID drive array can be conceptually structured as an array of rows and columns, each column representing a different storage unit and each row representing a sequential storage address in the storage unit.

The method 300 comprises a step 301 splitting or dividing the data block into a plurality of sets of one or more data sub-blocks. This effectively comprising striping the data block into sets of sub-blocks, each set being destined or intended for storage in a different storage unit of the RAID drive array.

For improved performance in flash storage devices (i.e. where the storage units comprise flash storage devices), the size or height of each data sub-block may be matched to the underlying page size of the flash storage device.

The method 300 further comprises a step 302 of generating check data for the generated sets of one or more data sub-blocks. The check data is configured to enable the rebuilding or reconstruction of at least one of the sets of data sub-blocks from the other sets of data sub-blocks.

In a particular example, the sets of data sub-blocks and check data may conceptually form a region of data having rows and columns, the number of columns in the region being equal to the number of storage units (i.e. each representing a different storage unit). Each set of one or more data sub-blocks contributes a sub-block to each row of the region of data. The check data may contribute at least one check data sub-block/entry for each row of the region of data.

In some examples, a first check data sub-block may enable the reconstruction of at least one sub-block within the row of that region of data. Purely by way of example, a first check data sub-block may comprise an XOR parity calculation of the data sub-blocks in the same row.

In other examples, a second check data sub-block may enable the reconstruction of sub-blocks from different columns and different rows. For example, a second check data sub-block may enable the reconstruction of a data sub-block from a first row of a first column using a data sub-block from a second row of a second column and vice versa. This process is commonly called diagonal parity and would be apparent to the skilled person.

Other examples will be apparent to the skilled person, for example, a second check data sub-block may instead comprise a higher order computation of data sub-blocks within a same row.

From the foregoing, it will be apparent that the check data may comprise one or more sets of one or more check data sub-blocks, the total number of check data sub-blocks in each set being equivalent to the number of data sub-blocks in each set of data sub-blocks.

The number of sets of data sub-blocks may depend upon the number of check data sub-blocks generated and the total number of storage units. In particular, the number of sets of data sub-blocks may be no greater than the total number of storage units, subtracting the total number of check data sub-blocks generated for each row of data. This depends upon implementation details.

After generating check data in step 302, the method moves to a step 303 of writing the data and the check data. This step comprises writing each set of data sub-blocks and each set of check data sub-blocks to a different storage unit.

The method 300 further comprises a step 304 of generating location metadata, usable to identify the location of sub-blocks of the data within the RAID drive array. The location metadata may be forward lookup information that enables the identification of the physical location of a data sub-block within the RAID drive array.

The method may perform step 304 at a same time as step 302 or step 303, depending upon implementation details.

The method then stores the location metadata in a step 305. The method stores a copy of the location metadata in at least two of the storage units, so that the location metadata is mirrored. This provides redundancy for the forward lookup metadata.

If location metadata for a previous version of the data block to be stored exists (e.g. is to be superseded), step 305 may comprise overwriting the existing location metadata with new location metadata, so that future attempts to read the data block (e.g. by addressing its logical location) will cause the reader to be directed towards the most up-to-date version of the data block stored in the log-structured RAID drive array.

If not all of the storage units of the RAID drive array have the same performance characteristics, the method may store location metadata on drives specialized for a (4K) random read and write IO, since location metadata updates are the primary drive of a (4K) random read and write.

The method may then move to a step 306 of generating an indication that the data write has been completed. This can be passed to a processing system to mark the write as complete.

In preferable embodiments, the method further comprises a step 307 generating and storing identifying metadata, i.e. reverse lookup data, together with the sets of data sub-blocks. The identifying metadata identifies a relationship between a physical location of the each data sub-block of the data block within the RAID drive array and the logical address for the data sub-block within a log.

The identifying metadata may also be adapted to hold and store invalidation information, e.g. identifying which portions of the physical data storage have been superseded, e.g. by later writes in the log. Alternatively, the method may store invalidation information in a separate data component to the identifying data.

The method may further comprise a process 308 for identifying and writing invalidations. This process may comprise a step 308A of, after generating location metadata, checking whether previous/old location metadata exists for a previous/old/superseded version of the data block. In the event that such previous location metadata exists, invalidation data may be generated and/or staged in a step 308B. The method then writes the invalidation data in a step 308C to enable previous/old/superseded data to be identified.

The method may comprise writing the invalidation data to a same data component as the identifying metadata, i.e. form part of the identifying metadata. However, in other embodiments, the method stores invalidation data in a separate data component to the identifying metadata.

The method may store copies of the identifying metadata, in a similar manner to the location information, in a plurality of different storage units of the RAID drive array. Thus, step 307 may comprise generating at least two copies of the identifying metadata and storing each copy in a different storage unit of the RAID drive array.

In some embodiments, the method generates and stores more copies of the location metadata in different storage units than copies of the identifying metadata. This is because the identifying metadata can be rebuilt or reconstructed from the identifying metadata.

In some embodiments, the method does not mirror or copy invalidation data to multiple storage units, rather storing invalidation data in only a single storage unit. This embodiment may be used when the cost or penalty of keeping a mirror of invalidations up to date outweighs the benefits of not losing a disk of invalidations. As invalidation information is not essential for a clean-up or garbage collection process of the log-structured RAID drive array because location metadata must be necessarily consulted in any event to prevent the deletion of active or current data sub-blocks it is not necessary to restore lost invalidation information.

Preferably, the method performs step 307 of generating and storing identifying metadata (reverse lookup data) before step 305 of storing the location metadata (forward lookup data). This helps ensure that the forward lookup data, i.e. the location metadata, is correct despite any interruptions in the storage of data.

Thus, the method may perform step 307 of generating and storing identifying metadata at a same time as the generation of location metadata. The method may stage or cache location metadata while the identifying metadata is being written in step 307.

Preferably, if performed, the method executes step 308C after storing the location metadata in step 305. This is because invalidation information is not essential to the correct operation of a RAID drive array operating under a log-structured filing system, as any clean-up operation of the RAID drive array will necessarily cross-reference the location metadata before deleting or removing superseded stored data.

The method may physically store the identifying metadata stored in the RAID drive array alongside the sets of data sub-block(s). For example, the method may store the identifying metadata in a same region of data as the sets of data sub-block(s) and the check data, where the region of data is conceptually distributed across the storage units of the drive array. The method may store location metadata in a separate element of the RAID drive array. In one example, the method stores location metadata in a top portion of the RAID drive array but stores the data block and identifying information in a bottom portion of the RAID drive array.

For improved performance, embodiments may comprise maintaining a cache of the location metadata, e.g. in a dedicated cache memory, to improve access times to data stored in the RAID drive array. In such embodiments, it is preferable for the method to update the cache with the location metadata before performing step 306, i.e. any new/modified metadata be written to disk, to prevent the cache containing dirty or outdated data, which could lead to an incorrect read operation.

For improved performance, embodiments may comprise maintaining a cache of invalidation data, e.g. in a dedicated cache memory, to improve an ease of performing a clean-up operation or garbage collection on the RAID drive array. A cache of invalidation data is permitted to contain dirty or outdated data.

The skilled person would appreciate that the described method of writing data to a RAID storage array enables quick restoration of location metadata redundancy in the event of a storage unit failure.

If greater redundancy protection is desired, the method may comprise storing more than two copies of the identifying metadata in different storage units.

If undertaking the above-described method, and using a single copy of the location metadata in which the storage units have a 4 KB sector size, a 32 KB host write will turn into a 4 KB read, two 4 KB writes, 32 KB of a large write shared with other IO, contribute towards a parity write shared with other IO, and a small reverse lookup write shared with other IO. There is also a small read/write for invalidations which can be performed after IO has completed.

This compares with two 32 KB writes for raid 1, or three 32 KB reads and three 32 KB writes for raid 6. That the large drive writes are shared between many host IO's reduces the required bandwidth compared with standard raid implementations.

In some embodiments, the method may compress each data sub-block. The method 300 may be adapted to perform compression when generating the data sub-blocks. Alternatively, methods may compress data during a later clean-up operation, e.g. if write performance is being bottlenecked by compression steps during a writing process.

When a data sub-block undergoes compression, the location metadata may further comprise an indication of an offset within a data storage location of the RAID drive array, the offset indicating the beginning of the compressed data sub-block within the data storage unit. The location metadata may also indicate the size of the compressed data sub-block, e.g. the number of addresses that need to be read to obtain the data and/or the exact compressed size of the data sub-block (e.g. in KB or B).

Table 1 below illustrates an example RAID drive array layout in which a data block is stored in a configuration analogous to a RAID 5 configuration, whereas location metadata and, optionally, identifying metadata for the data block is stored using a configuration analogous to a RAID 1 configuration.

The RAID drive array of Table 1 comprises three storage units or disks (Disk 1, Disk 2 and Disk 3).

The copies of the location metadata (FW1-FW3) are distributed across the RAID drive array, so that no single storage unit stores multiple copies of the same location metadata. The RAID drive array stores the location metadata at a top of the RAID drive array. FW1 describes the physical location of the first number of virtual/logical sectors of data in the raid array. FW2 describes the next x sectors and so on.

The RAID drive array stores the data of interest (Data 1a, Data 1b . . . , Data 12a, Data 12b) at a bottom of the RAID drive array. The RAID drive array stores the check data for the data of interest (Parity 1, Parity 2, . . . Parity 12) alongside the data of interest. The RAID drive array rotates the data and check data between different data regions to help even out the IO load between drives, e.g. rather than providing a dedicated storage unit for the check data.

The RAID drive array intersperses the data of interest with identifying data (RV1-RV2), i.e. reverse look-up metadata, which provides information on the logical address associated with a physical region/portion of data of the RAID drive array. The number of pieces/sub-blocks of data in each region of data depends on the number of pieces/sub-blocks that can be described by a single block of reverse lookup data. If RV1 can describe 8 rows of data, then the RAID data array would have data 1x through data 8x, then RV1, before starting the next data region.

TABLE 1

| Disk 1 | Disk 2 | Disk 3 |
|---|---|---|
| FW1 | FW1 | FW2 |
| FW2 | FW3 | FW3 |
| . . . | . . . | . . . |
| Data 1a | Data 1b | Parity 1 |
| Data 2a | Data 2b | Parity 2 |
| . . . | . . . | . . . |
| RV1 | RV1 | Unused |
| Parity 11 | Data 11a | Data 11b |
| Parity 12 | Data 12a | Data 12b |
| . . . | . . . | . . . |
| Unused | RV2 | RV2 |

From Table 1, it is clear that the RAID drive array achieves redundancy for the metadata by mirroring the metadata across multiple storage units, whereas RAID drive array achieves redundancy for the data by storing check data for reconstructing the data. In this way, metadata redundancy can be regained quickly after a storage unit failure by copying the metadata to a new or hot storage unit.

Table 2 below illustrates another example RAID drive array layout in which a data block is stored in a configuration analogous to a RAID 6 configuration, whereas location metadata and, optionally, identifying metadata, for the data block is stored using a configuration analogous to a RAID 1 configuration.

TABLE 2

| Disk 1 | Disk 2 | Disk 3 | Disk 4 | Disk 5 |
|---|---|---|---|---|
| FW1 | FW1 | FW2 | FW2 | Rebuild |
| Rebuild | FW3 | FW3 | FW4 | FW4 |
| . . . | . . . | . . . | . . . | . . . |
| Data 1a | Data 1b | Parity 1p | Parity 1q | Rebuild |
| Data 2a | Data 2b | Parity 2p | Parity 2q | Rebuild |
| . . . | . . . | . . . | . . . | . . . |
| RV1 | RV1 | RV2 | RV2 | Rebuild |
| Rebuild | Data 11a | Data 11b | Parity 11p | Parity 11q |
| Rebuild | Data 12a | Data 12b | Parity 12p | Parity 12q |
| . . . | . . . | . . . | . . . | . . . |
| Rebuild | RV3 | RV3 | RV4 | RV4 |

The RAID drive array of Table 2 comprises five storage units or disks (Disk 1, Disk 2, Disk 3, Disk 4 and Disk 5). The RAID drive array is conceptually structured as an array of rows and columns, each column representing a different storage unit and each row representing a sequential storage address in the storage unit. The RAID drive array is configured so that, in each row, at least one of the columns is free for rebuilding the RAID drive array in the event of storage unit failure. In other words, the RAID drive array is configured so that each row of the RAID drive array comprises at least one free storage address for the purposes of rebuilding or reconstructing data.

The RAID drive array stores check data (Parity xp and Parity xq) that enables the reconstruction of the data or check data from the loss of any two disks.

Parity xp is computed from data in a same row. Parity xq may be diagonal (e.g. computed from data 1a and data 2b) or a higher order computation from data in the same row. Either way, recovery of data is possible even with the loss of disk 1 and disk 2.

Simultaneous loss of disk 1 and disk 2 would result in metadata loss, and hence the loss of the RAID drive array even if data could be reconstructed.

Preferably, in the event of a rebuild, location metadata should be rebuilt first to reduce the likelihood of a second drive failure before metadata redundancy has been restored. e.g. after the loss of Disk 3, first FW2 would be copied from Disk 4 row 0 to Disk 5 row 0, then FW3 copied from Disk 2 to Disk 1, and so on. Once location metadata is copied, the data can be reconstructed, and then finally the identifying metadata can be copied. This is because non-superseded reverse lookup can always be reconstructed from location metadata in the event of loss of both copies of the identifying metadata.

As a tweak to ensure full double drive redundancy, location metadata can use three copies. Preferably, one rebuild area per row is still provided.

Tables 1 and 2 also help illustrate how a read operation of the RAID drive arrays can be performed. In particular, a processor/controller could perform a read operation performed by simply staging the location metadata, using the staged location metadata to identify the physical location of a desired piece of data and reading the physical location of the desired piece of data.

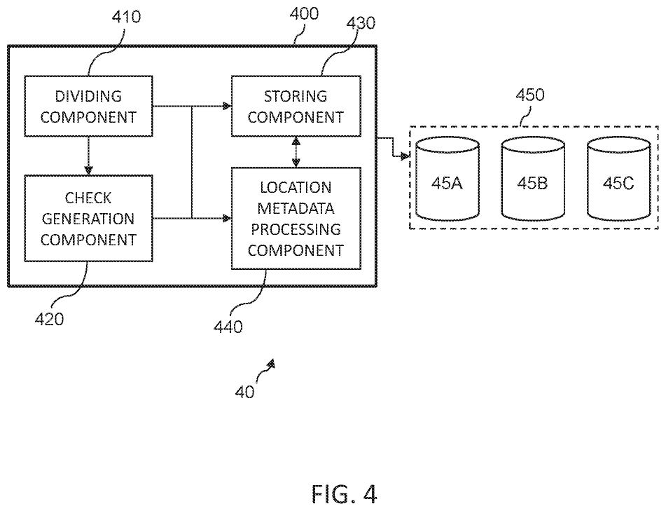

Referring now to FIG. 4, there is depicted a simplified block diagram of an exemplary embodiment of a processing system 400 for storing a data block in a RAID drive array.

The processing system 400 may form part of an overall computing system 40, which is itself an embodiment of the invention, and which further comprises a RAID drive array 450 formed of a plurality of storage units 45A-45C.

The processing system 400 comprises a dividing component 410 configured to divide the data block into at least two sets of one or more data sub-blocks.

The processing system 400 further comprises a check generation component 420 configured to generate check data for the at least two sets of one or more data sub-blocks, the check data enabling the reconstruction of one of the sets of one or more data sub-blocks using the other set or sets of one or more data sub-blocks.

The processing system 400 also comprises a storing component 430 configured to store each set of one or more data sub-blocks and the check data in a different storage unit.

The processing system 400 further comprises a location metadata processing component 440 configured to, for each data sub-block and the check data obtain location metadata that identifies a physical location for the data sub-blocks within the storage unit in which the respective data sub-blocks are stored.

The storing component 430 is further configured to store a copy of the location metadata in at least two storage units.

The skilled person would be readily capable of modifying any of the components of the described processing system 400 to enable the processing system 400 to perform any herein described method.

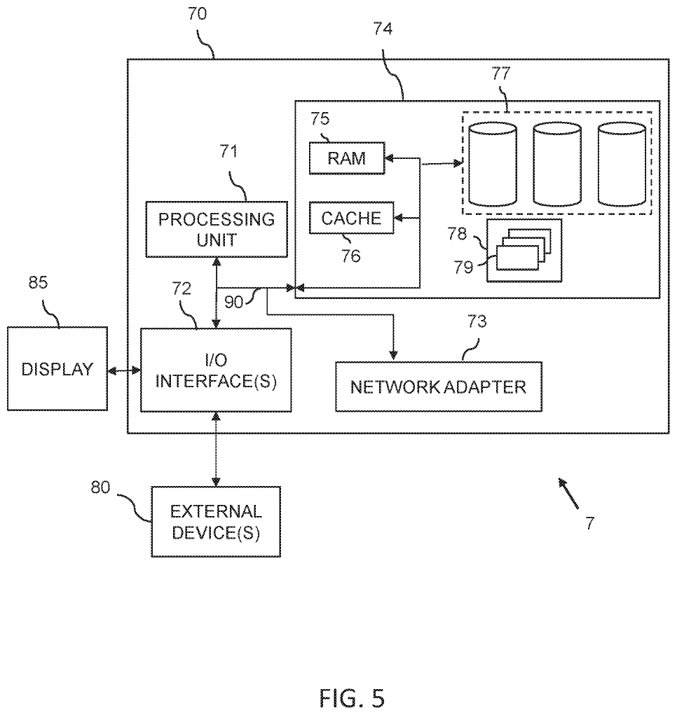

By way of further example, as illustrated in FIG. 5, embodiments may comprise a computer system 70, which may form part of a networked system 7. For instance, a processing system may be implemented by the computer system 70. The components of computer system/server 70 may include, but are not limited to, one or more processing arrangements, for example comprising processors or processing units 71, a system memory 74, and a bus 90 that couples various system components including system memory 74 to processing unit 71.

The system memory 74 may here comprise a RAID drive array 77 in which a data block is stored, e.g. formed from at least three storage units.

System memory 74 can include computer system readable media in the form of volatile memory, such as random access memory (RAM) 75 and/or cache memory 76. Computer system/server 70 may further include other removable/non-removable, volatile/non-volatile computer system storage media. In such instances, each can be connected to bus 90 by one or more data media interfaces. The memory 74 may include at least one program product having a set (e.g., at least one) of program modules that are configured to carry out the functions of proposed embodiments. For instance, the memory 74 may include a computer program product having program executable by the processing unit 71 to cause the system to perform a method for storing a data block in the RAID drive array 77 using a log-structured filing system.

Program/utility 78, having a set of program modules 79, may be stored in memory 74. Program modules 79 generally carry out the functions and/or methodologies of proposed embodiments for storing a data block in a plurality of at least three storage units forming a RAID drive array, the RAID drive array operating using a log-structured filing system.

Computer system/server 70 may also communicate with one or more external devices 80 such as a keyboard, a pointing device, a display 85, etc.; one or more devices that enable a user to interact with computer system/server 70; and/or any devices (e.g., network card, modem, etc.) that enable computer system/server 70 to communicate with one or more other computing devices. Such communication can occur via Input/Output (I/O) interfaces 72. Still yet, computer system/server 70 can communicate with one or more networks such as a local area network (LAN), a general wide area network (WAN), and/or a public network (e.g., the Internet) via network adapter 73 (e.g. to communicate recreated content to a system or user).

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

The present invention may be a system, a method, and/or a computer program product. The computer program product may include a computer readable storage medium or media having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method for storing a data block in a plurality of at least three storage units forming a RAID drive array, the RAID drive array operating using a log-structured filing system, the computer-implemented method comprising:
dividing the data block into at least two sets of data sub-blocks;
generating check data for the at least two sets of data sub-blocks, the check data enabling the reconstruction of one of the sets of data sub-blocks using the other set or sets of data sub-blocks;
storing each set of data sub-blocks and the check data in a different storage unit;
obtaining location metadata that identifies a physical location for the data sub-blocks within the storage unit in which the respective data sub-blocks are stored; and
storing a copy of the location metadata in at least two storage units.

2. The computer-implemented method of claim 1, wherein the location metadata identifies a relationship between a logical address for the data block and a physical location of the data block within the RAID drive array.

3. The computer-implemented method of claim 1, wherein:
the plurality of storage units comprises at least four storage units;
further comprising:
the step of generating check data comprises generating a first check data sub-block and a second, different check data sub-block, the first and second check data sub-blocks together enabling the reconstruction of two of the sets of data sub-blocks using the other sets of data sub-blocks; and
the step of storing each set of data sub-block and the check data comprises storing each set of data sub-blocks and each check data sub-block in a different storage unit.

4. The computer-implemented method of claim 1, further comprising:
obtaining identifying metadata for the block of data; and
storing the identifying metadata in at least two storage units.

5. The computer-implemented method of claim 4, wherein the identifying metadata identifies a relationship between a physical location of the data sub-blocks of the data block within the RAID drive array and the logical address for the data sub-block within a log.

6. The computer-implemented method of claim 4, wherein the steps of obtaining and storing identifying metadata are performed before storing the location metadata.

7. The computer-implemented method of claim 1, wherein the step of storing a copy of the location metadata in at least two storage units comprises storing a copy of the location metadata in at least three storage units.

8. The computer-implemented method of claim 1, wherein the generated location metadata is the same size as the sector size of any of the storage units.

9. The computer-implemented method of claim 1, wherein the location metadata identifies the size of the sub-block.

10. The computer-implemented method of claim 1, wherein the location metadata comprises a compression flag indicating whether or not a sub-block has been compressed.

11. A computer program product comprising a computer-readable storage medium having a set of instructions stored therein which, when executed by a processor, causes the processor to perform a method by:
dividing the data block into at least two sets of data sub-blocks;
generating check data for the at least two sets of data sub-blocks, the check data enabling the reconstruction of one of the sets of data sub-blocks using the other set or sets of data sub-blocks;
storing each set of data sub-blocks and the check data in a different storage unit;
obtaining location metadata that identifies a physical location for the data sub-blocks within the storage unit in which the respective data sub-blocks are stored; and
storing a copy of the location metadata in at least two storage units.

12. The computer program product of claim 11, wherein the location metadata identifies a relationship between a logical address for the data block and a physical location of the data block within the RAID drive array.

13. The computer program product of claim 11, wherein:
the plurality of storage units comprises at least four storage units;
further causing the processor to perform a method by:
the step of generating check data including generating a first check data sub-block and a second, different check data sub-block, the first and second check data sub-blocks together enabling the reconstruction of two of the sets of data sub-blocks using the other sets of data sub-blocks; and
the step of storing each set of data sub-block and the check data including storing each set of data sub-blocks and each check data sub-block in a different storage unit.

14. The computer program product of claim 11, further causing the processor to perform a method by:
obtaining identifying metadata for the block of data; and
storing the identifying metadata in at least two storage units.

15. A processing system for storing a data block in a plurality of at least three storage units forming a RAID drive array, the RAID drive array operating using a log-structured filing system, the processing system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to perform a method by:
dividing the data block into at least two sets of data sub-blocks;
generating check data for the at least two sets of data sub-blocks, the check data enabling the reconstruction of one of the sets of data sub-blocks using the other set or sets of data sub-blocks;
storing each set of data sub-blocks and the check data in a different storage unit;
obtaining location metadata that identifies a physical location for the data sub-blocks within the storage unit in which the respective data sub-blocks are stored; and
storing a copy of the location metadata in at least two storage units.

16. The processing system of claim 15, wherein the location metadata identifies a relationship between a logical address for the data block and a physical location of the data block within the RAID drive array.

17. The processing system of claim 15, wherein:
the plurality of storage units comprises at least four storage units;
further causing the processor to perform a method by:
the step of generating check data including generating a first check data sub-block and a second, different check data sub-block, the first and second check data sub-blocks together enabling the reconstruction of two of the sets of data sub-blocks using the other sets of data sub-blocks; and
the step of storing each set of data sub-block and the check data including storing each set of data sub-blocks and each check data sub-block in a different storage unit.

18. The processing system of claim 15, further causing the processor to perform a method by:
obtaining identifying metadata for the block of data; and
storing the identifying metadata in at least two storage units.

19. The processing system of claim 18, wherein the identifying metadata the identifying metadata identifies a relationship between a physical location of the data sub-blocks of the data block within the RAID drive array and the logical address for the data sub-block within a log.

20. The processing system of claim 18, wherein the steps of obtaining and storing identifying metadata are performed before storing the location metadata.
